(19) United States
(12) Patent Application Publication
(10) Pub. No.: US 2012/0130894 A1
(43) Pub. Date: May 24, 2012

(54) System and method for ATM ODF notification (Automatic Teller Machine overdraft fee notification)

(76) Inventor: Billy James Pendleton, Chicago, IL (US)

(21) Appl. No.: 13/373,232

(22) Filed: Nov. 8, 2011

Related U.S. Application Data
(60) Provisional application No. 61/456,540, filed on Nov. 9, 2010.

(51) Int. Cl. G06Q 40/02

(52) U.S. Cl. 705/43

(57) ABSTRACT

A method for providing an ATM customer with notification of an impending overdraft fee if transaction is completed to ensure that the customer is aware of overdraft fees prior to completion of a transaction, and has the opportunity to agree to fees, or to modify or cancel the requested transaction.

### RELATED TO U.S. APPLICATION DATA

This patent application claims the benefit, under 35 U.S.C 119(e), of U.S. Provisional Patent Application Ser. No. 61/456,54.0, entitled “System and Method for ATM ODF Notification (Automatic Teller Machine Overdraft Fee Notification)” to Pendleton, Billy and filed on Nov. 9, 2010, which is fully incorporated herein by reference as describing and illustrating subject matter (in part(s) or in its entirety) that can be practiced with the subject matter disclosed herein.

### FIELD OF THE INVENTION

This business concept relates to a better solution for ATM (Automatic Teller Machines) transactions that resulted in overdraft fees without many ATM and debit card customers knowledge.

### BACKGROUND OF THE INVENTION

This same situation happened to me concerning overdraft charges at the ATM on Mar. 9, 2009. I drove through the ATM that I bank with to make a withdrawal. After my ATM transaction was completed, I looked at my receipt and noticed a negative sign next to the amount I had withdrawn. At that moment, I wondered why the negative amount was showing. I didn't take out more than what was in my account.

I called the local branch of where I bank the next morning, Mar. 10, 2009 at 9:58 am, but no one was able to assist me, so I was referred to a customer service number. When I called customer service, they informed me that I had withdrawn “unavailable” funds that were not accessible at the time of my transaction. The reason I was told that the funds were unavailable was due to monies not cleared at the time of my transaction. I asked the bank representative why the ATM allowed me to draw out the funds only to be charged an overdraft fee without any warning of a fee for funds that were not supposed to be available to me. The representative further explained that the bank sometimes allows the transaction to be completed, and sometimes it does not. In this case, because the transaction was completed, the overdraft fee could not be waived.

This really bothered me and I stated to the representative that the bank needs to install a feature on all their ATMs that would indicate and let customers know the status of their accounts before allowing an overdraft charge to take place. A simple notification on the screen by the ATM that would clearly display/indicate overdraft charges will be applied to the account upon agreeing to accept the overdraft charge, with the option to disagree and modify the transaction.

As the call ended, the idea for this concept became even clearer to me that my process is a relevant solution to this problem. This concept gives clarity to the customers as well as the banks. ATMs in the past have produced similar problems concerning charges made at the ATM for using a foreign ATM (ATM belonging to another bank). Many customers had no knowledge that they were being charged a fee for the usage of another bank's ATM until they received their monthly statement. The solution to that problem was to provide an option to agree or disagree to accept the charges to use the foreign ATM. My idea to agree or disagree to accept the overdraft fee at the ATM offers the answer to this scenario. Many customers would pay the overdraft fee anyway when the funds are needed, just like they do with the usage of a foreign ATM. And those customers that do not agree to accept the overdraft fee can easily disagree and modify their withdrawal amount, or simply end the transaction. Banks could receive revenue from overdraft charges without the dark cloud that appeared as a hidden fee.

When I got home that night on Mar. 10, 2009, I immediately began to write down this scenario and my idea for ATMs to provide the option to agree or disagree to accept the overdraft charges due to unavailable or inefficient funds. On Apr. 3, 2009, I realized I needed to legalize this document that I had written concerning my idea. I had it notarized at my bank as verification and proof of the inception date of my idea. My concept for ATM overdraft notification is extremely effective for all parties involved—customers and bank institutions.

### SUMMARY OF THE INVENTION

On Mar. 9, 2009, when I encountered this scenario that many people are faced with in relation to being charged an overdraft fee without warning, this made me realize that a solution is needed, and gave me the idea for an ATM overdraft notification system. With this feature, the ATM now can offer the option to agree or disagree to receive the overdraft fee. This concept clearly benefits all parties involved.

### BRIEF DESCRIPTION OF DRAWINGS

The disclosure may be more completely understood in consideration of the detailed description of the method that follows in connection with the accompanying drawing as follows:

FIG. 1 shows a flow diagram of the ATM transaction with overdraft notification consistent with an embodiment of the present disclosure.

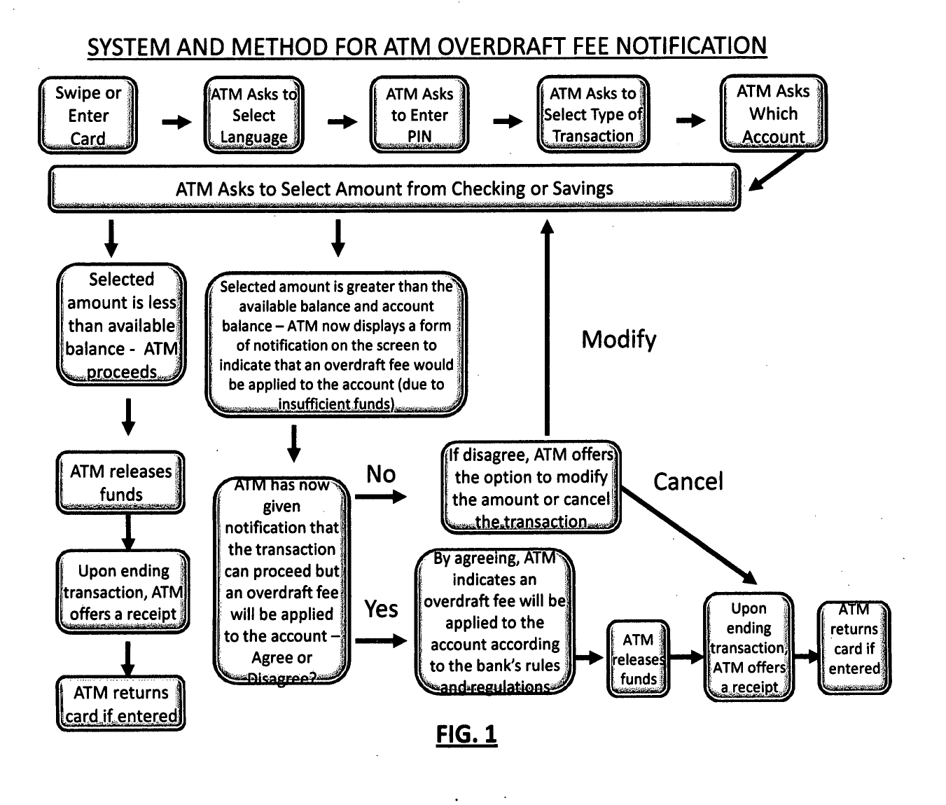

### DETAILED DESCRIPTION OF INVENTION

I have devised a simple yet extremely effective business method that minimizes overdraft fees concerning ATM transactions.
1. Swipe or enter card
2. ATM ask to select language
3. ATM ask to enter PIN number
4. ATM ask to select type of transaction
5. ATM ask which withdrawal from which account
6. ATM ask select amount from checking or savings
   Scenario I
      Selected amount is less than available balance—ATM proceeds
      ATM releases funds
      Upon ending transaction, ATM offers a receipt
      ATM returns card, if entered
   Scenario II
      Selected amount is greater than the available balance and the account balance, ATM now displays a form of notification* on the screen to indicate that an overdraft fee would be applied to the account (due to insufficient funds) *Some forms of this notification can be as follows:The ATM displays a message on the screen alerting that an overdraft fee will be charged if this transaction proceedsThe ATM releases an audio alert to indicate that an overdraft fee will be charged if this transaction proceedsThe ATM displays flashing words—Words on the screen flash to indicate that an overdraft fee will be charged if transaction proceedsThe ATM releases a beeping sound and displays flashing words—A beeping sound accompanied by a flashing message on the screen alerting that an overdraft fee will be charged if this transaction proceedsThe ATM gives warning of automatic card removal with print out alerting that overdraft fee will be charged if this transaction proceeds
      ATM has now given notification that the transaction can proceed but an overdraft fee will be applied to the account—agree or disagree?
         If disagree, ATM offers the option to modify the amount or cancel the transaction
            Upon ending transaction, ATM offers a receipt
            ATM returns card, if entered
         By agreeing, ATM indicates an overdraft fee will be applied to the account according to the bank's rules and regulations
            ATM releases funds
            Upon ending transaction, ATM offers a receipt
            ATM returns card, if entered

### OBJECTS AND ADVANTAGES

My business concept consists of an overdraft message alert system provided by ATMs when the available balance is less than the amount being withdrawn at the ATM.
Provides a much needed solution for ATM and debit card transactions
This concept allows ATMs to offer the decision to agree or disagree to accept the overdraft charge at the ATM
Takes a few seconds to read
This concept delivers peace and clarity with the status of overdraft charges

Note: Available Balance means balances in accounts where there is a delay in crediting funds to an account. If a deposit has not been cleared by the issuing bank, the funds may not be available to the account holder even though they may show up in the account's stated total funds.

The net effect is that the account balance may be different from the balance that is available to the account holder for spending, withdrawal or transfer.

What is claimed is:

1. A method for automatic teller machine overdraft transactions, said method comprising:
determining if a customer's requested transaction amount is less than or equal to the customer's available account balance;
providing a form of notification of overdraft fees if requested amount is greater than the customer's available account balance;
receiving the customer's agreement or declination of overdraft fee if desired amount is greater than the customer's available balance; and
completing the transaction in accordance with the customer's response.

2. The method of claim 1, wherein the determination of the customer's available balance is accomplished by retrieving the customer's account information and matching against received input data from customer.

3. The method of claim 1, wherein the form of notification is selected from the group consisting of an audible alert, a visual alert, and a flashing visual alert.

4. The method of claim 1, further comprising allowing the customer to modify the requested transaction amount if the transaction amount is greater than the customer's available account balance.

5. A method for handling automatic teller machine transactions, comprising:
allowing a customer to enter or swipe a card;
requesting and receiving the customer's entry of a security code;
allowing the customer to select a type of requested transaction;
allowing the customer to select a desired amount;
providing a form of notification to the customer if the desired amount is greater than the customer's available balance; and
allowing the customer to agree or disagree with payment of an overdraft fee for completing the transaction.

6. The method of claim 5, further comprising allowing the customer to select a language to be used for transaction.

7. The method of claim 6, further comprising allowing the customer to select an account type for transaction.

8. The method of claim 5, further comprising completing the requested transaction if desired amount is less than or equal to the customers available balance.

9. The method of claim 5, further comprising allowing the customer to modify or cancel the transaction if they disagree with payment of overdraft fee.

10. An automatic teller machine implemented overdraft notification method comprising:
executing software based instructions using one or more computer processors, where said instructions cause the automatic teller machine to:
receive customer specific input for verification;
receive transaction data;
determine whether customer has sufficient available funds to complete requested transaction;
provide a notification when customer does not have sufficient available funds to complete transaction;
receive customer's selection of whether or not to proceed with requested transaction, or to cancel or modify the requested transaction; and
implement completion, modification or cancellation of requested transaction in accordance with the customer's selection.

11. The method of claim 10, wherein the customer specific input includes entering or swiping of customer's card, and entry of customer's personal code.

12. The method of claim 10, wherein the received transaction data includes the customer's account type and amount of desired withdrawal.

13. The method of claim 10, wherein the notification is comprised of one or more of the following: an on screen alert message, a visible notification, an audible alert, a flashing screen message, an audible alert and an on screen alert message.

14. The method of claim 10, wherein the notification is a visible alert message.
